(19) United States
(12) Patent Application Publication
(10) Pub. No.: US 2012/0182548 A1
(43) Pub. Date: Jul. 19, 2012

(54) NANOFLUIDIC CELL

(75) Inventors: Maher Harb, Sanby (SE); Alex Paarmann, Biendorf (DE); Jason Dwyer, Narragansett, RI (US); Dwayne R. J. Miller, Mississauga (CA)

(73) Assignee: INSIGHT NANOFLUIDICS INC, Toronto, ON (CA)

(21) Appl. No.: 13/386,567

(22) PCT Filed: Jul. 23, 2010
(86) PCT No.: PCT/CA2010/001139

§ 371 Date: Mar. 29, 2012

Related U.S. Application Data
(60) Provisional application No. 61/227,893, filed on Jul. 23, 2009.

(51) Int. Cl. G01N 1/10; B32B 37/14; B32B 37/02

(52) U.S. Cl. 356/246; 156/182

(57) ABSTRACT

A flow cell is provided for the analysis and/or microscopy of liquid or gas samples on the nanometer to micron scale. The flow cell preferably includes a thin membrane that is transparent to electrons and/or photons, thereby enabling the penetration of electrons or photons into a liquid flowing through the cell. Trenches are provided on either side of the membrane, which advantageously minimize fluidic resistance outside of the window area of the cell and also enable a faster response time in response to changes in external fluidic pressure. This feature enables active feedback using pathlength sensitive probes to stabilize the fluid flow to thin streams from nanometer to micron scale thicknesses with nanometer precision.

### CROSS-REFERENCE TO RELATED APPLICATION

This application claims priority to U.S. Provisional Application No. 61/227,893 titled “NANOFLUIDIC CELL” and filed on Jul. 23, 2009, the entire contents of which are incorporated herein by reference.

### FIELD OF THE INVENTION

The present invention relates to devices and methods for the analysis of nanoliter or sub-nanoliter fluid volumes via analytical methods including electron, x-ray, and optical characterization.

### BACKGROUND OF THE INVENTION

Microscopy and materials characterization methods typically employ light, electrons, acoustic waves and other forms of electromagnetic radiation to investigate optical, electronic and/or structural properties of a sample of interest.

Electron microscopy is among the most powerful tools in resolving structure at the atomic level. Unlike its optical counterpart that is limited by the wavelength of visible light, electron microscopy utilizes electrons in the range of 10 keV to 1 MeV to probe matter. In this energy range, electrons have sub-angstrom wavelength and are therefore capable of directly imaging atomic arrangements, yielding a magnification power of up to approximately 10⁶. Unfortunately, the penetration depth of electrons, by virtue of their high scattering cross-section, is limited to 100 nm length scales or less. Samples must be prepared with thickness of nanoscale dimensions such that sample preparation is a major component to the art of electron microscopy.

In addition to electron microscopy, there are important applications where the penetration of the probing interaction is so small that it has been impossible to study strongly absorbing samples. The application of soft x-rays for structural analysis also involves absorption depths on the 100 nm scale. Similar probes arise in the use of infrared probes of molecular vibrations in liquids. This problem is particularly severe for electrons where one would like to image biological samples under aqueous conditions. Sample path-lengths, including windows, are preferably kept under the 100 nm scale. Consequently the use of an electron microscope demands preparing thin samples.

Such a constraint essentially limits the application of electron probes and other powerful tools of structure to studying samples in the solid phase where structural rigidity permits 100 nm thick sections. However, even in this case, there are important limitations. For example, to determine the structure of a protein using electron diffraction, one has to first crystallize the protein and subsequently prepare a stable thin film from the crystal. The crystallization process involves a certain degree of dehydration of the sample, and is thought to alter the structure of the protein to be investigated.

Ideally, one would like to study systems in their natural environment. Since most biological systems occur in solution, one would ultimately like to directly probe liquids without any manipulation that causes denaturation, evaporation or other degradation of the sample. A solid structure that is capable of confining samples to nano-scale thicknesses yet allowing electrons or radiation to penetrate the structure is therefore needed.

### SUMMARY OF THE INVENTION

The present invention addresses this need by providing a flow cell that enables the probing of fluid samples. Furthermore, the flow cell is adapted for use with optical, x-ray, acoustic and electron analysis and/or microscopy by providing a device in which a membrane is included that is transmissive to electrons, acoustic waves or photons over a selected energy range, thereby enabling the probing of the contents of the flow cell with electrons, photons, or acoustic waves while providing a flow path having reduced fluidic resistance outside of the probed region.

Accordingly, in a first aspect, there is provided a flow cell comprising a body structure comprising an internal channel, an inlet port and an outlet port, wherein the inlet port and the outlet port are in flow communication with the internal channel; the body structure further comprising a membrane enclosing a portion of the internal channel and defining a detection zone within the internal channel, wherein a thickness of the membrane is selected to allow the transmission of a probe beam within a selected energy range through the membrane and into the channel; and wherein transverse dimensions of the internal channel outside of the detection zone are selected to provide a fluidic resistance outside of the detection zone that is less than a fluidic resistance within the detection zone. The probe beam may be an optical beam, an x-ray beam, an electron beam, and an acoustic beam.

The thickness of the internal channel within the detection zone is preferably on a micron to submicron scale, and more is preferably within the range of approximately 100 nm to 100 microns, and the thickness of the membrane is on a nanometer scale, and is more preferably within the range of approximately 10 to 1000 nanometers. The area of the membrane is preferably less than approximately 1 mm². The thickness of the internal channel outside of the detection zone is preferably greater than approximately 10 microns. The membrane may comprise a material selected form the group consisting of silicon nitride, boron nitride, silicon carbide, silicon, silicon dioxide, carbon, diamond and other allotropes of carbon, molybdenum disulphide and graphene.

The internal channel preferably further comprises trenches provided adjacent to the detection zone, wherein the trenches comprise transverse dimensions that are selected to provide a fluidic resistance outside of the detection zone that is less than a fluidic resistance within the detection zone. Surfaces within the internal channel may be coated with a hydrophobic material or a hydrophilic material.

The body structure may further comprise a second membrane on an opposing side of the channel within the detection zone, wherein a thickness of the membrane is selected to allow the transmission of the probe beam through the membrane.

The net fluidic resistance of the internal channel is preferably such that fluctuations in the thickness of the membrane due to pressure changes occur on timescales ranging from approximately 1 ms to 10 seconds. In another aspect, there is provided a flow cell, comprising a first substrate having a transparent layer provided on a surface thereof, wherein the transparent layer is transparent to a probe beam within a selected energy range; an aperture formed in the first substrate, the aperture extending through the first substrate and exposing a membrane comprising a portion of the transparent layer; a second substrate; a spacer layer contacting the transparent layer and a surface of the second substrate, the spacer layer having provided therein an opening defining a channel, the channel in flow communication with the membrane within a detection zone of the channel; an inlet port and an outlet port provided in one of the first and second substrates, wherein the inlet port and the outlet port are in flow communication with the channel; and first and second trenches provided on adjacent sides of the detection zone within one of the first and second substrates, the trenches contacting the channel for increasing a thickness of the channel on either side of the detection zone; wherein the trenches comprise transverse dimensions selected to provide a fluidic resistance outside of the detection zone that is less than a fluidic resistance within the detection zone. The probe beam may be an optical beam, an x-ray beam, an electron beam, and an acoustic beam.

The first and second substrates may each comprise silicon, and the transparent layer may comprises a material selected form the group consisting of silicon nitride, boron nitride, silicon carbide, silicon, silicon dioxide, carbon, diamond and other allotropes of carbon, molybdenum disulphide and graphene.

The thickness of the channel within the detection zone is preferably on a micron to submicron scale, and is more preferably within the range of approximately 100 nm to 100 microns. The thickness of the membrane is preferably on a nanometer scale, and is more preferably within the range of approximately 10 to 1000 nanometers. The area of the membrane is preferably less than approximately 1 mm².

The second substrate may have a second transparent layer provided on a surface thereof, with the second transparent layer contacting the spacer layer, wherein the second transparent layer is transparent to the probe beam within the selected energy range, and wherein the flow cell further comprises a second aperture formed in the second substrate, the second aperture comprising an aperture extending through the second substrate and exposing a second membrane comprising a portion of the second transparent layer, and wherein the first aperture is aligned with the second aperture for the transmission of the probe beam through the flow cell.

The spacer layer may be formed from a material selected from the group consisting of silicon dioxide, polycrystalline silicon, amorphous silicon, photoresist, Teflon™ and titanium.

A net fluidic resistance of the flow cell is preferably such that fluctuations in the thickness of the membrane due to pressure changes occur on timescales ranging from approximately 1 ms to 10 seconds.

In yet another aspect, there is provided a system for controlling a thickness of an internal channel within a flow cell, the system comprising a flow cell as described above; a flow means for flowing the sample to the inlet port and removing the sample from the outlet port; means for detecting a signal related to the thickness of the internal channel; and a processing and control means for controlling the flow means in response to the signal for controlling the thickness of the internal channel.

In another aspect, there is provided an electron microscope system adapted for the analysis of a fluid sample within a fluidic cell, the system comprising an electron microscope comprising a chamber; a flow cell as described above, wherein the flow cell is provided within the chamber; and a flow means for flowing the sample to the inlet port and removing the sample from the outlet port. The electron microscope is preferably selected from the group consisting of a transmission electron microscope, scanning electron microscope, scanning-tunneling electron microscope, and environmental scanning electron microscope.

In yet another aspect, there is provided a method of analyzing a fluid sample with a flow cell, the flow cell comprising a body structure comprising an internal channel, an inlet port and an outlet port, wherein the inlet port and the outlet port are in flow communication with the internal channel; the body structure further comprising a membrane enclosing a portion of the internal channel and defining a detection zone within the internal channel, wherein a thickness of the membrane is selected to allow the transmission of a probe beam within a selected energy range through the membrane and into the channel; and wherein transverse dimensions of the internal channel outside of the detection zone are selected to provide a fluidic resistance outside of the detection zone that is less than a fluidic resistance within the detection zone; the method comprising the steps of flowing the sample to the inlet port and through the internal channel; directing the probe beam onto the membrane; and detecting one of a reflected probe beam and a transmitted probe beam. The sample may comprise biological cells within a liquid. The flow of the sample through the cell is preferably controlled by an external sample delivery means.

The probe beam may be an electron beam, wherein the flow cell is housed within a chamber of an electron microscope. The electron microscope may be selected from the group consisting of a transmission electron microscope, scanning electron microscope, scanning-tunneling electron microscope, and environmental scanning electron microscope.

The thickness of the internal channel is preferably actively controlled by detecting a signal related to the thickness of the internal channel; processing the signal to obtain a feedback parameter related to a difference between a thickness of the internal channel and a desired thickness of the internal channel; and controlling the flow means to optimize the feedback parameter. The fluidic resistance within the cell is preferably sufficiently low to actively control the thickness of the channel, and the thickness of the channel is preferably controlled on timescales from 1 ms to 10 seconds, and with nanometer precision.

If X-rays are generated within the sample, a thickness of the channel may controlled by monitoring an x-ray yield and adjusting a pressure within the flow cell. In an embodiment where the probe beam is an electron beam, the thickness of the channel may be controlled by monitoring an amount of attenuation of the electron beam transmitted through the flow cell and adjusting a pressure within the flow cell. Alternatively, when the probe beam is an electron beam and an interaction of the electron beam with the membrane produces a crystalline diffraction pattern, a thickness of the channel may be controlled by monitoring an intensity of one or more features within the diffraction pattern and adjusting a pressure within the flow cell.

In another aspect, there is provided a method for fabricating a flow cell, comprising the steps of a) providing an upper substrate; b) depositing a transparent layer onto a bottom surface of the upper substrate, wherein the transparent layer is transparent to a probe beam within a selected energy range; c) forming an aperture within the upper substrate, the aperture extending through the upper substrate, by removing a portion of the upper substrate and exposing a membrane comprising a portion of the transparent layer; d) providing a lower substrate; e) depositing a spacer layer onto one of the transparent layer of the upper substrate and an upper surface of the lower substrate, and removing a portion of the spacer layer to define a channel; e) forming an inlet port and an outlet port in one of the upper substrate and the lower substrate; f) forming first and second trenches provided on adjacent sides of the membrane within one of the upper and lower substrates; and g) aligning and adhering the first and second substrates; wherein the membrane defines a detection zone within the channel; and wherein the channel is in flow communication with the membrane, the trenches, the inlet port and the outlet port for flowing a sample through the detection zone within the flow cell, and wherein the trenches comprise transverse dimensions selected to provide a fluidic resistance outside of the detection zone that is less than a fluidic resistance within the detection zone.

The method may further comprise the steps of: after performing step (d), providing a second transparent layer on a top surface of the lower substrate, wherein the second transparent layer is transparent to the probe beam; and forming a second aperture within the lower substrate, the second aperture extending through the lower substrate, by removing a portion of the lower substrate and exposing a second membrane comprising a portion of the second transparent layer; wherein when the upper substrate is aligned and adhered with the lower substrate, the first aperture is aligned with the second aperture.

The transparent layer preferably comprises a material selected form the group consisting of silicon nitride, boron nitride, silicon carbide, silicon, silicon dioxide, carbon, diamond and other allotropes of carbon, molybdenum disulphide and graphene, and the spacer layer is preferably formed from a material selected form the group consisting of silicon dioxide, polycrystalline silicon, amorphous silicon, photoresist, Teflon™ and titanium.

The method may further comprise the step of coating one or more surfaces within the flow cell with a hydrophobic or hydrophilic material, where the hydrophilic material may be silicon dioxide.

The aperture, inlet port, outlet ports, and first and second trenches may be formed by photolithography or reactive ion etching.

A thickness of the membrane is preferably within the range of approximately 10 to 1000 nanometers.

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1 shows a schematic of a fluidic cell, including views of (a) vertical section through a central plane of the cell, (b) the upper cell surface, and (c) the lower cell surface.

FIG. 2 shows a schematic illustrating the fabrication steps of the device.

FIG. 3 shows an image of the membrane area of a nanofluidic cell, in which fluorescence from within the cell is detected through the membrane. The cell is empty in FIG. 2(a) and filled with Rhodamine in FIG. 2(b).

FIG. 4 shows a holder used to clamp two halves of a nanofluidic cell together, with drawings of (a) the upper and (b) lower pieces of the holder, and an image (c) of the two pieces shown side by side.

FIG. 5 shows the interference pattern obtained when imaging through the membrane within a nanofluidic cell, in which the cell is (a) evacuated, (b) partially filled with air, and (c) pumped with air.

FIG. 6 provides a flow chart illustrating a method of actively controlling the sample thickness during a measurement.

FIG. 7 shows a schematic of a fluidic system in which a nanofluidic cell is placed inside a vacuum chamber.

### DETAILED DESCRIPTION OF THE INVENTION

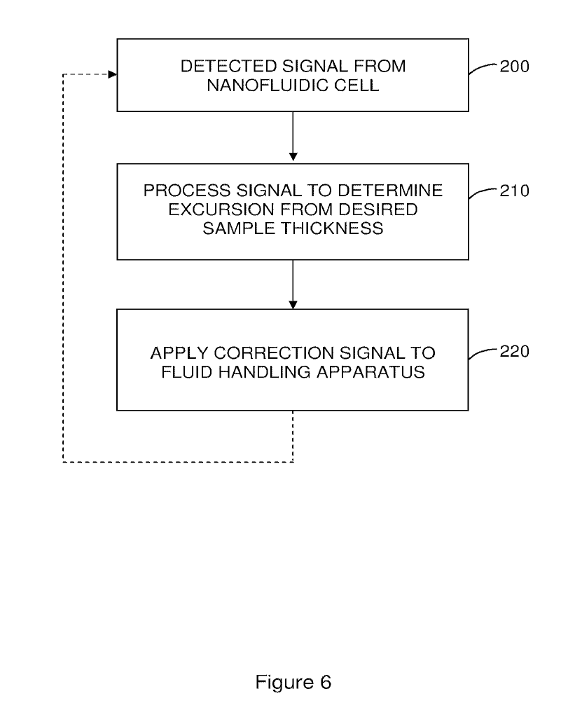

Generally speaking, the systems described herein are directed to a fluidic cell. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Furthermore, various aspects of the invention may be further reduced in scale by using standard microfluidic concepts for flowing fluids involving micropumps and valves as a replacement of the macroscale syringe pumps shown in FIG. 6. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to nanofluidic cells.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the coordinating conjunction “and/or” is meant to be a selection between a logical disjunction and a logical conjunction of the adjacent words, phrases, or clauses. Specifically, the phrase “X and/or Y” is meant to be interpreted as “one or both of X and Y” wherein X and Y are any word, phrase, or clause.

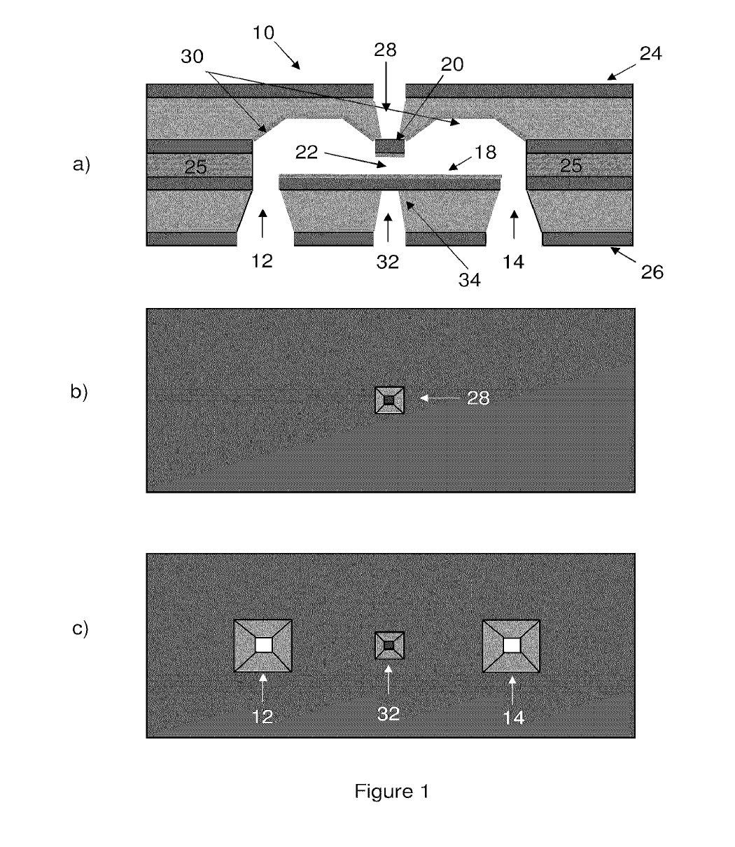

A fluidic cell according to one embodiment is shown in cross-section in FIG. 1(a). The cell, shown generally at 10, includes an inlet port 12, and outlet port 14, an internal flow path between the ports 12 and 14, and a membrane 20. Membrane 20 and internal surface 18 located below the membrane define the narrowest portion 22 of the flow path. As used herein. the term “membrane” refers to a planar segment enclosing a portion of the internal flow path, having a thickness selected to enable incident electrons, acoustic waves, light, x-rays, and/or other forms of electromagnetic radiation to enter the nanofluidic cell without experiencing significant attenuation, thus enabling the internal fluid to be probed. In non-limiting examples, the membrane may comprise a locally thin portion of a substrate or may comprise a portion of a layer deposited onto a substrate, where the membrane portion of the layer comprises an internal surface enclosing a portion of the flow path, and an external surface exposed to the external environment.

Fluid enters the cell through the inlet port, passes through a channel between the membrane 20 and the internal surface 18, and exits through the outlet port. All fluid entering the inlet port must pass through the channel prior to exiting through the outlet port. In the embodiment shown in FIG. 1(a), the channel is formed by the presence of a spacer layer 25.

FIGS. 1(b) and 1(c) show top and bottom views of the flow cell. The cell includes an upper surface 24 and a lower surface 26, and further includes a viewport 28 extending from the upper surface 24 to the outer surface of the membrane 20. The inlet port 12 and outlet port 14 are located in the lower surface 26. Viewport 28 is provided to expose the external surface of membrane 20 to the external environment and recess the membrane from the top surface 24 of the flow cell. As shown in FIG. 1(b), the membrane 20 extends in a direction perpendicular to the plane of the page in FIG. 1(a) to produce a square planar structure. Alternate shapes and geometries may be provided, such as a rectangular or circular planar shape. The cross-sectional area of the membrane is selected based on the properties of the material chosen and the application-specific window thickness.

In a preferred embodiment in which the membrane comprises silicon nitride, the cross-sectional area is less than about 1 mm², and the thickness of the membrane is between 10 and 1000 nm. In embodiments in which the membrane material comprises amorphous carbon or graphene, the membrane thickness may be less than 10 nm. The preferred thickness of the membrane depends on the nature of the beam used to probe the sample flowing through the nanofluidic cell. In the case of x-rays, a preferred thickness range is from approximately 100 nm to 10 μm. In electron microscopy applications, including electron holography, a preferred thickness range is from approximately 10 to 100 nm. When the sample is probed via optical radiation, a preferred thickness range is from approximately 10 nm to 10 μm. Thicker membranes allow a larger unsupported surface area, due to the increased mechanical strength afforded by the material thickness.

The thickness of the narrow channel 22 formed between the membrane and the internal surface is selected to enable the probing of the sample under investigation, depending on the amount of absorption of the incident probe beam by the sample. Specifically, the density and absorption cross-section of the sample will dictate the preferred thickness of the channel. Furthermore, in applications in which it is desirable to include characterization where a primary probing beam causes emission of a secondary beam (e.g. primary incident photons producing secondary electron emission), then the sample and membrane must have a thickness that is selected to allow the secondary beam to be emitted and be collected by the detector. Non-limiting examples of secondary beams include optically generated beams such as sum frequency generation and harmonic generation; acoustic waves such as photo-acoustic generated waves, and secondary beams from scanning electron microscopy including secondary and back-scattered electrons, x-rays, and cathodoluminescence.

The thickness of the narrow channel 22 may also be selected to allow the passage of particles, cells or other species within the fluid. While a preferred thickness range for the fluid flow defining the sample pathlength includes approximately ten nanometers to approximately ten microns, thicker or thinner pathlengths are also contemplated by embodiments of the invention. The thickness of the channel giving rise to the sample path-length is preferably controlled by the thickness of the spacer layer 25.

The thickness of the channel 22 also depends on whether the probe beam will be detected in reflection mode or in transmission mode. In reflection mode, the signal obtained may be less sensitive to the thickness of the channel. However, in transmission mode, the signal obtained is highly sensitive to the thickness of the channel.

In an embodiment in which the cell is to be used in transmission mode, the cell further includes a second viewport 32 extending from the lower surface 26 to the outer surface of a second membrane 34. In this embodiment, the minimum channel thickness 22 occurs between the first and second membranes 20 and 34. As shown in FIG. 1, the second membrane may comprise a portion of internal surface 18 that extends in a transverse plane spatially beyond the first membrane 20, or vice-versa, as the smaller membrane defines the spatial extent of the channel. The second viewport 32 enables the transmission of the probe beam through the first membrane 20, narrow channel 22, and second membrane 34, where it may be imaged, detected, or otherwise appropriately processed according to the desired application.

In order to reduce fluidic resistance within the nanofluidic cell and support the analysis of large fluid volumes in shortened time periods, the flow path outside of the narrow channel 22 has a cross-sectional area that exceeds the cross-sectional area within the membrane region. An illustrative embodiment is shown in FIG. 1(a), which is not to scale, where the cross-sectional height in the vertical direction in the regions 30 on either side of the membrane region is shown as being larger than the thickness of the narrow channel 22. Preferably, the cross-sectional dimensions in at least a portion of the non-membrane region are greater than approximately 10 microns.

In the specific embodiment shown in FIG. 1(a), trenches 30 are provided on either side of the narrow channel 22, producing an increased cross-sectional area orthogonal to the flow direction that tapers in size towards the channel. This design and similar designs with a narrow channel but otherwise broad flow path allow fluid to pass through the cell with minimal fluidic resistance. Accordingly, the flow channels of the present device have dimensions such that the probed region is filled whenever flow is achieved between the two access ports of the device. In addition, the high flow-resistance region is preferably limited to the narrow channel 22 to reduce fluidic resistance, resulting in rapid filling rates and an improved response to external pressure. Both features can be beneficial when actively controlling the flow of sample through the cell using an external pump, as further described in additional embodiments below.

In a preferred embodiment, the fluidic resistance within the flow cell is sufficiently low such that the time response of membrane deformations to pressure changes occurs on timescales from approximately 1 ms to 10 sec to support active feedback stabilization of the channel thickness. Active stabilization of the channel thickness is of significant importance when the membrane has a thickness on the nanometer to micron scale, and is prone to mechanical deformation.

In methods known in the prior art, to this invention, it was not possible to flow fluids, gases or liquids, without causing either mechanical instabilities in the path length or rupture of the membrane or a lack of confinement of the liquid to the flow channels. However, in transmission-based imaging and spectroscopic methods, one requires stable sample thicknesses so as to not obscure or blur the observable. The embodiments disclosed herein thus provide a flow cell having dimensions that reduce resistance to fluid flow so as to decrease the response time of membrane deformations and associated path-length variations, thereby permitting active feedback stabilization of the fluid flow. This approach can be employed to achieve stable flow with sample path-lengths variable from the nanometer to micron scale with path-length stabilization of nanometer precision as required for the stated applications.

More preferably, the active control mechanism is adapted to control the height of the channel 22 with precision on a nanometer length scale. Laterally, the preferred distance between the access ports of the device is on the order of 1 cm. Such a macroscopic distance is preferred to allow sufficient space for O-rings or other sealing devices or means that interface the ports with a device holder (discussed in further detail below) and to have a view port in the center of the device through which the sample is probed. As noted above, driving fluids over centimeter distances within a channel having a cross-sectional height that is very small, for example, in the nanometer or micron range, is problematic due to the extremely low flow rates. For instance, calculations show that the time it takes for water to cross a 1 cm length channel, with 100 nm cross-section is approximately 5 minutes. A slow filling time implies a slow response time to changes in external pressure. A fast response time is desirable for actively controlling the bowing of the viewports using the transmitted (or reflected) signal as feedback (as discussed further below).

Therefore, as shown in FIG. 1, trenches which widen the cross-sectional length of the flow region adjacent to the narrow channel 22 are included for achieving fast flow rates. In a preferred embodiment, the trenches have a thickness on a micron scale, and more preferably have a thickness of at least 10 microns. The narrow channel 22 in the membrane region, where high flow-resistance occurs, is preferably on the nanometer to micron scale. Preferably, the channel has a minimum thickness less than approximately 1 micron, and more preferably less than about 100 nm. The minimum thickness preferably occurs over a transverse length that is less than approximately 1 mm, and more preferably less than about 500 μm. In a preferred embodiment, this results in <1 sec filling time of the cell. In a preferred embodiment, one or more internal surfaces forming the internal flow path may be coated with a material that modifies the surface properties of the internal flow path, such as the surface tension, hydrophobicity or hydrophilicity to increase surface adhesion and assist flow through capillary forces as appropriate for the fluid of interest. Alternatively, chemical agents may be added to the fluid to change its surface tension.

Although FIG. 1(a) shows the second membrane 34 as having approximately the same size (i.e. freestanding spatial extent) as the first membrane, various embodiments may be practiced with different sized membranes. Furthermore, while the internal surface 18 extends spatially beyond the second membrane 34, it is also possible for the internal surface 18 to be formed essentially membrane 34, as in the case of the first membrane 20. Accordingly, trenches such as those shown in FIG. 1 may also be provided adjacent to the second membrane 34, thereby limiting the spatial extent of the internal surface 18.

In another embodiment, the inlet and outlet ports may be provided in the upper surface of the cell instead of the lower surface, or alternatively laterally in the sides of the cell. Alternatively, the inlet and outlet ports may be provided on opposite sides of the cell.

In a preferred embodiment, the nanofluidic cell is fabricated on two separate substrates that are joined (e.g. clamped or bonded together). Suitable clamping or bonding means include but are not limited to mechanical clamping, adhesives, ultrasonic welding, thermal annealing, anodic bonding, and silicon fusion bonding. In another embodiment, the nanofluidic cell comprises two substrates that are identically processed and subsequently joined to form a cell according to the aforementioned embodiments. Secondary inlet or outlet ports may be used to add additional fluid or supplementary buffers or reagents, or to provide an additional means to control the pressure within the cell. Alternatively, the ports may be provided in the side of the cell, or opposite upper and lower surfaces of the cell, in which case the two substrates may be joined to provide a single inlet port and a single outlet port.

While the cell may be fabricated from a single type of material, a preferred embodiment includes separate layers for the membrane. The layers may be formed by coating a surface of the substrates and subsequently processing the coated layer to remove most of the layer, leaving only the small planar region forming the membrane. More preferably, a spacer layer 25 formed from a third material is included for defining and assisting in maintaining the thickness of the channel outside of the membrane region.

In a preferred embodiment, the substrates are formed from silicon wafers, although other wafer materials known in the art, such as wafers comprising other semiconductor materials, may be employed. In an embodiment in which the substrates are silicon, the membrane is preferably formed from silicon nitride. In another preferred embodiment, the membrane is boron nitride. In other embodiments, the membrane may be formed from silicon carbide, graphene, carbon films, diamond and other allotropes of carbon, molybdenum disulphide, silicon and silicon dioxide. The spacer layer may formed from a layer of silicon dioxide, polycrystalline or amorphous Si, photoresist, Teflon™ spacers, titanium spacers, and other spacer materials known in the art.

In applications involving electron microscopy, the membrane is preferably a SiN membrane with a thickness of approximately 50 nm, which is a suitable thickness for use as a view port. The surface area of the view ports is preferably approximately 50×50 um², sufficient for the electron beam in a TEM to pass through. A preferred minimum channel thickness as defined by spacer layer (preferably SiO₂) is about 100 nm.

A nanofluidic cell according to embodiments described herein may be formed using a variety of known materials processing methods, including, but not limited to, chemical vapor deposition, lithography, chemical etching, micromachining, laser micromachining, and embossing, or any combination thereof. In a preferred embodiment, chemical vapor deposition, lithography and chemical etching are used to achieve the desired microstructure. In addition, implementations that require a thicker (for example, greater than 10 um) channel may employ a machined Teflon or silicone spacer to define the sample length.

The following example provides a preferred embodiment of the nanofluidic cell and a method for forming the nanofluidic cell. In a preferred embodiment, the cell is formed from two substantially planar substrates with channels formed therein that are pressed or clamped together to form the internal flow path, where the one or both of the substrates includes a thin layer forming the membrane. Preferably, the substrates are silicon and the membrane is low stress silicon nitride, which can be back-etched to form the membrane on one or both of the silicon substrates using potassium hydroxide (KOH). The thickness of each of the silicon nitride membranes is preferably less than 50 nm. With reference to FIG. 1, the minimum channel thickness between the silicon nitride membranes may be defined by a spacer 25, preferably comprising silicon oxide, that is deposited on one or both substrates before the matching pieces of the structure are clamped or bonded together. The narrow channel 22 may then be formed by etching the silicon oxide spacer layer using buffered oxide etch (BOE). The depth of the narrow channel 22 is defined by the thickness of the deposited silicon oxide layer. This is chosen based on the characteristics of the sample under investigation, for example, the density and the electron (or X ray) scattering cross-section or the optical absorption, and can preferably range from a few tens of nanometers to a few microns. In experiments where macroscopic sample lengths are desired (such experiments involving hard X rays, where sample thicknesses can be 10-100 μm), the silicon oxide spacer may be replaced by another spacer made from a material capable of forming a fluidic seal, such as Teflon™. For hydrophilic liquids, a 5 nm coating layer of silicon oxide may be applied in order to enhance the flow rate, or chemical agents may be added to the fluid to change its surface tension.

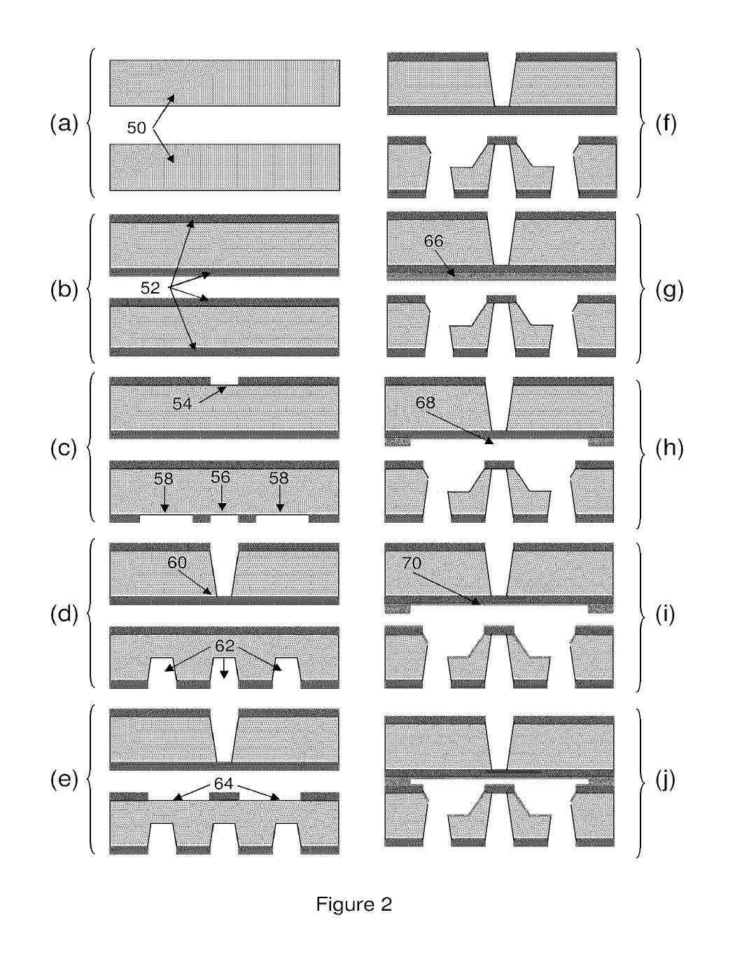

FIG. 2 illustrates the fabrication steps of a nanofluidic cell according to a preferred embodiment. It is to be understood that the fabrication steps described below provide a non-limiting example and that a nanofluidic cell according to embodiments disclosed above may be fabricated by a variety of other methods. Starting with a pair of Si substrates 50 (FIG. 2(a)), a low pressure chemical vapor deposition chamber is used to deposit a layer of low stress silicon nitride 52 on both sides of each substrate (FIG. 2(b)). A combination of photolithography and reactive ion etching is used to create the window pattern 54 in the top substrate, and the window pattern 56 plus the two access holes patterns 58 in the bottom substrate (FIG. 2(c)). KOH is used to etch the exposed window pattern in the top substrate from the top surface to the silicon nitride layer, resulting in a free-standing membrane 60, and the exposed features 62 on the bottom substrate are etched partially (preferably about half-way) through the bulk of the Si substrate (FIG. 2(d)). A combination of photolithography and reactive ion etching is used to create the two trench patterns 64 in the bottom substrate (FIG. 2(e)). This process involves backside alignment of the photolithographic mask with the already etched KOH features during the previous step. The bottom substrate is inserted again into KOH so that etching proceeds from both sides of the substrate, thus joining the access holes 58 with the trenches 64 (FIG. 2(f)). To form the spacer layer, a layer of silicon oxide 66 is deposited on one side of the top substrate using plasma enhanced chemical vapor deposition (FIG. 2 (g)). Alternatively, a layer of polycrystalline silicon may be deposited and subsequently oxidized to form the spacer layer. A combination of photolithography and buffered oxide etching is used to define the channel pattern 68 in the top substrate (FIG. 2(h)) (note that in this example, the steps shown in FIGS. 2(g) and 2(h) may be executed any time after the step shown in FIG. 2(d). In an optional step, the hydrophilicity of the finished surfaces may be enhanced by depositing a layer of silicon oxide 70 (preferably approximately 5 nm) using plasma enhanced chemical vapor deposition (FIG. 2 (i)). Alternatively, if a nonpolar solvent is employed, the surfaces may be made hydrophobic. Once clamped or bonded together, the fabricated structure forms an enclosure bounded by two silicon nitride windows and accessible to the outside world through a system of channels (FIG. 2 (j)).

While the above example describes a method of fabricating a nanofluidic cell in which the inlet and outlet ports are located in the lower substrate forming the cell, and the trenches are also provided in the lower substrate the cell, it will be readily apparent to those skilled in the art that other orientations of the inlet and outlet ports and the trenches are possible. For example, the inlet and outlet ports can be provided in the upper substrate, or alternatively one port may be located in the upper substrate and another port can be located in the lower substrate. Also, the trenches can be located in the upper substrate, as illustrated in FIG. 1. As noted above, in an alternative embodiment, the ports may be formed in the side of the cell.

The fabrication steps described in FIG. 2 represent one embodiment in which the trenches and access ports are created in the bottom substrate while the spacer is created in the top substrate. In general there is no preference with respect to which substrate (top or bottom) each of these 3 features (trenches, access ports, and spacer) should be created in. For instance, in an alternative embodiment all 3 features are created in the same substrate, while the second substrate contained only a view port. In this case, the fabrication of the spacer should be done as the final step because the other two features require KOH etching, which is destructive to the SiO₂ spacer.

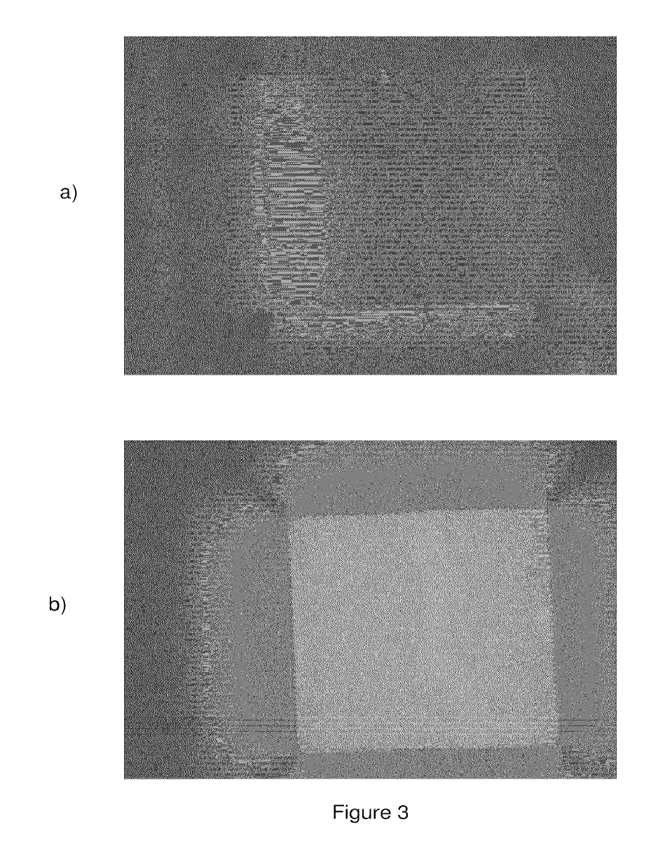

Optical microscope images of the sample area of a nanofluidic cell fabricated according to the steps described in FIG. 2 are shown in FIG. 3. FIG. 3(a) is an image of an empty cell under taken under illumination in the 450-490 nm. FIG. 3(b) is a picture of a cell filled with Rhodamine dye in solution to clearly demonstrate the liquid filled the nanofluidic cell.

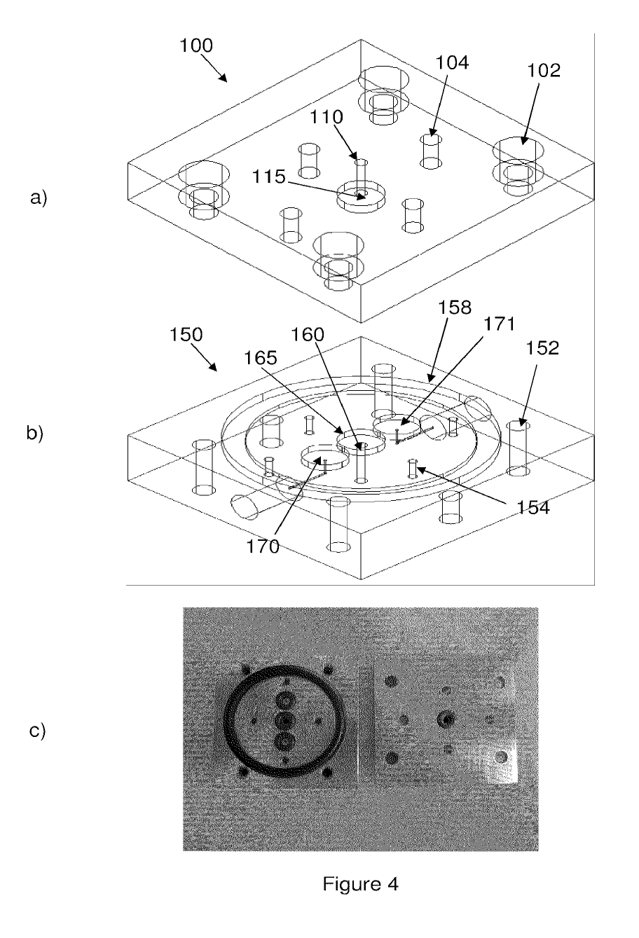

A stainless steel sample holder was designed to clamp together the matching pieces of the nanofluidic cell. FIGS. 4(a) and 4(b) show the upper 100 and lower 150 pieces of the holder, respectively, and FIG. 4(c) shows a photograph of the two disassembled pieces of the sample holder. The nanofluidic cell is clamped between the two pieces of the holder, and the holder allows sample delivery to the cell chamber through a system of embedded channels.

The top piece of the holder includes four holes 102 for inserting fasteners (not shown) that are received in threaded holes 152 in the bottom piece of the holder. Also included in the top piece are four holes 104 for supporting guide pins (not shown) that are received in adjacent holes 154 in the bottom piece. The incident beam for illuminating the sample is directed through a central via 110 in the top piece that terminates in a cylindrical opening 115. Similar features are provided in the bottom piece at 160 and 165, respectively to enable the detection of the beam transmitted through the sample. An o-ring (shown in the image) is included in each cylindrical opening to protect against fluid leakage in the event of the rupture or breakage of the membrane.

The cell is aligned between the holders so that the inlet port 12 and outlet port 14 are positioned directly above the central opening in the two lateral cylindrical openings 170 and 171 in the bottom piece. The lateral cylindrical openings are connected to channels that include a right angle, thus enabling the fluid to be pumped into and out of the holder in the horizontal plane. The channels connect on one end to the inlet and outlet ports of the cell and seal via o-rings, and on the other end to flat-bottom ports that are used to fasten 1/16″ tubing to the holder using standard fluidic fittings. As shown in FIG. 4(b), the channel can be narrowed prior to connecting with the cylindrical openings 170 and 171 to limit the volume of sample. The inner region of the holder is further optionally protected from leaks by the incorporation of an outer o-ring, which is shown in the image and is housed in the circular indentation 158.

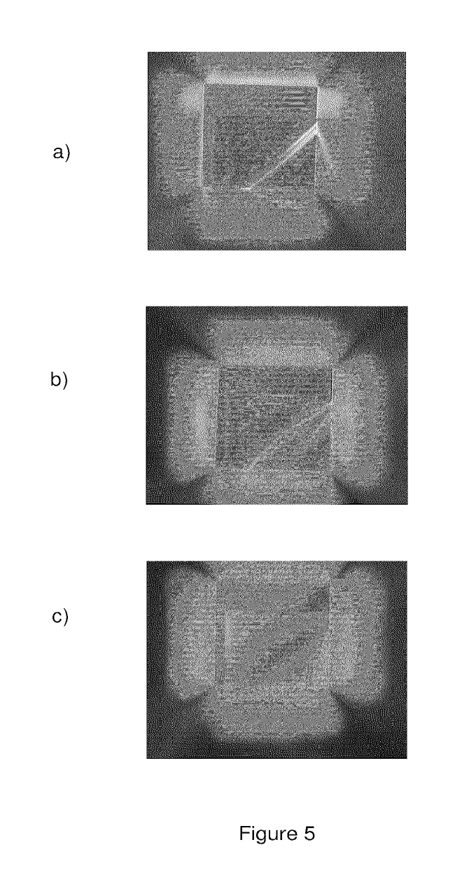

A common problem in dealing with a nanoscale thin membrane is that the flexibility of the membrane causes it to bow due to both the residual stress from the deposition process, and the difference in pressure between the cell chamber and the outside environment. Bowing may result in a sample thickness that greatly exceeds the gap as defined by the silicon oxide spacer. This effect is demonstrated in FIG. 5, where the sample chamber was optically imaged under different pressure conditions. In FIG. 5(a), the sample chamber is evacuated, leading to the collapse of the two silicon nitride membranes. In FIG. 5(b), the sample is partially filled with air. In FIG. 5(c), the sample chamber is completely pumped with air. The interference fringes indicate variation in the cell thickness over the membrane area.

The problem may be addressed by actively controlling the pressure inside the cell chamber using a computer-controlled pump and feedback from measurements made in the cell. As shown in the flow chart provided in FIG. 6, a signal, such as transmission through the cell may be monitored in step 200. A computer or processor is employed in step 210 to process the measured signal, where a pre-determined relationship between the measured signal and the channel thickness is employed to infer a deviation of the channel thickness from a preferred value. In step 220, a feedback signal is provided to the fluid handling apparatus for maintaining a controlled sample thickness throughout the period over which a measurement or experiment is carried out. This process may be repeated to actively stabilize the flow cell. As noted in aforementioned embodiments, the trenches, which limit the high resistance-flow region to the sample area, play an important role in the active control mechanism since they essentially reduce the response time of the system to changes in pumping pressure. A responsive system, in turn, allows the feedback error to converge quickly. This system also explicitly exploits the high damping of fluids over this timescale to produce a stable flow pattern through the cell.

The aforementioned method in which the total transmitted or reflected field, intensity or power is monitored to stabilize the geometry of the cell is best suited for applications in which the fluid flowing through the cell is homogeneous. In fluids with heterogeneity, variations in absorption may preclude the use of total field, intensity or power alone. Accordingly, a preferred embodiment involves analyzing the signal transmitted or backscattered from the cell and adjusting the applied cell pressure to keep some metric pertaining to the signal within the desired range. In optical spectroscopy, a useful metric could be the total transmitted power of the probing beam, while in electron microscopy it could be the total integrated intensity of the detected image. In a particular embodiment involving the generation of X-rays within a sample in a fluidic cell, the sample thickness may be controlled by a feedback method. X-ray generation from electrons interacting with the sample and sample cell are dependent upon several factors that can include the incident electron energy, the atomic composition of the cell windows and sample, and the thickness of the windows and sample. For a given sample, sample cell and fixed electron energy, actively changing the thickness of the sample by adjusting the fluid pressure will result in a change in the x-ray yield. Accordingly, in a preferred embodiment, the x-ray yield can be fed back to the pump in order to control the sample thickness in the cell through flexing of the membrane, as outlined in the previous feedback schemes.

In another embodiment involving an active feedback method, the sample thickness may be controlled via electron beam attenuation. An electron beam of fixed electron energy transmitting through a given substance inside a nanofluidic cell with fixed window thicknesses will be attenuated to a degree depending on the thickness of the sample. By monitoring the magnitude of the transmitted electron flux through the sample, for example, through the diminished signal from a phosphorescent screen or CCD detector or imaging plate or other readout device such as a microchannel-plate anode readout, one can use the degree of signal attenuation to directly monitor the thickness of the sample.

When using the electron beam in diffraction mode, a preferred method includes monitoring the intensity of the central s=0 (s is the scattering vector) spot using the method outlined above, or even a Faraday cup, for instance. The intensity of the central, s=0, spot will diminish with increasing sample thickness. In diffraction mode, an alternative embodiment involves monitoring the intensity of Bragg peaks or Debye-Scherrer rings in order to obtain a signal dependent on the sample thickness. With increasing sample thickness (fixed window thicknesses and for a given sample), the intensity distribution of the peaks (or rings) will change owing to sample-thickness-dependent multiple scattering. In a preferred embodiment, one may also stabilize the sample thickness by selecting a given intensity (chosen based on a criterion by which multiple scattering is minimized) and feedback the pump pressure to minimize the change in the intensity.

In another preferred embodiment, the sample thickness may be actively controlled by monitoring the diffraction pattern. When the nanofluidic cell window material gives a crystalline diffraction pattern (well-separated Bragg peaks), or polycrystalline diffraction pattern (Debye-Scherrer ring) or possibly even an amorphous ring, the scattering vectors at which those peaks or rings occur is a function of the unit cell dimensions. When the windows are bowed owing to an increase in sample pumping pressure that increases the sample thickness, then the macroscopic deflection of the windows may be detectable as a change in the diffraction-pattern-derived unit cell parameters. Changes in the diffraction pattern would indicate changes in the degree of deflection of the nanofluidic cell membranes, which in turn would indicate a change in the effective sample thickness. Therefore, in a preferred embodiment, the scattering vector magnitude for given diffraction pattern peaks/rings is used to feed back to the pump driving the sample in order to control the sample thickness. One skilled in the art will readily appreciate that this feedback method is dependent on being able to distinguish the diffraction pattern (or amorphous ring) of the nanofluidic cell windows from that of the sample.

To facilitate flow for such active feedback stabilization, the design implements a single channel that is wide enough to overlap with the area in between the silicon nitride membranes. Preferably, access holes which deliver the fluid to the cell chamber are connected to the channels imbedded in the sample holder through o-rings. Accordingly, the fluid has a single path to traverse from one inlet to the other. This feature is important for two reasons. First, it insures that the cell chamber is filled. Second, it allows efficient control of flow of sample in the cell chamber. In contrast, designs which rely on two silicon nitride windows without a channel system may flood the whole area outside the cell structure with the sample. In such devices, the fluid can potentially bypass the cell chamber once it faces resistance and instead go around the membrane region. This leads to an empty or partially filled cell that is unresponsive to applied pressure, therefore, offering no control over the sample thickness.

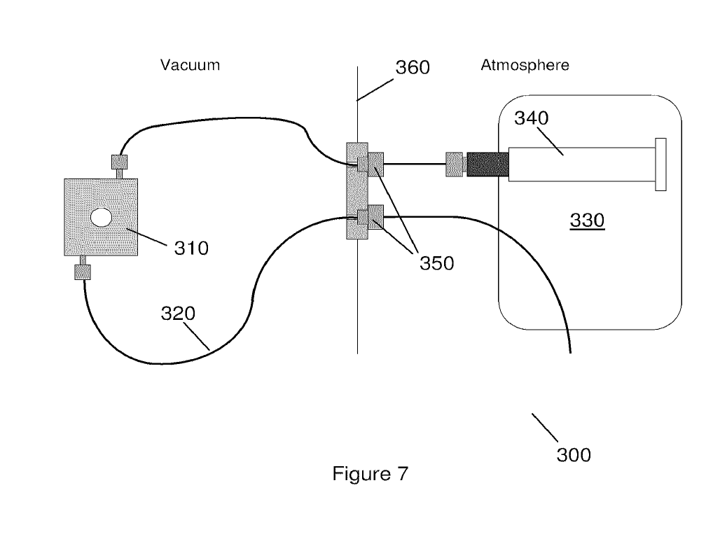

FIG. 7 shows a system including a nanofluidic cell system 300 according to the aforementioned embodiments. The system includes a nanofluidic cell housed in a holder 310, tubing 320 connecting the cell to a pump 330 and an output reservoir or a second pump (not shown). In a preferred embodiment, the pumps (i.e. sample delivery means) are syringe pumps 340. Actuation of the pump causes fluid (e.g. sample) to flow through the cell, where it can be investigated by directing a probe beam through the membrane surface. In a preferred embodiment, the pump system may be reduced in size by using microfluidic pumps and valves for the input and output feeds.

In a preferred embodiment, the system is employed in an electron microscope and the nanofluidic cell is located inside a vacuum chamber. Tubing and connection means such as ports and fittings 350 housed in the vacuum chamber wall 360 (or other fittings known in the art) are employed to connect tubing within the vacuum chamber to tubing under ambient conditions.

As will be appreciated by those skilled in the art, the nanofluidic cell disclosed herein can be adapted to a wide range of configurations and applications. Preferably, the nanofluidic cell is included within an electron microscope system, enabling the direct imaging and analysis of fluids (comprising liquids and gases), or the imaging of solids contained within fluids with an electron microscope. In a preferred embodiment, a system is provided for the analysis of various biological species in their natural fluidic environments, including, but not limited to, nucleic acids, proteins, and macromolecular assemblages such as cells.

While preferred embodiments of the cell are adapted for transmission and reflection measurements, other signal detection means may also be employed. For example, species inside a fluid flowing through the cell may be excited optically or with other means, such as an electron beam, and the emission of photons, acoustic waves or electrons may be detected. Exemplary applications include fluorescence, time-resolved fluorescence, luminescence, Raman scattering, surface-enhanced Raman scattering, X-ray diffraction, electron energy loss spectroscopy, photo-acoustic spectroscopy, and energy-dispersive X-ray spectroscopy.

In another embodiment, a system is provided for performing microscopy and analysis on biological fluids containing cells and other structures. For example, in one embodiment, the nanofluidic cell provides an improved cell for use in a flow-cytometer or particle analysis system. In particular, flowing biological cells through a nanofluidic cell enables electron microscope flow cytometry, which can be adapted for a wide range of research and clinical uses. The system can also be used for the imaging and analysis of nanoparticles in a fluidic or biological environment.

While the aforementioned embodiments have disclosed the use of liquid samples, or liquid samples containing biological media such as cells, the sample may alternatively comprise a gas.

Due to the fluidic nature of the nanofluidic cell system, additional embodiments contemplate uses and applications involving separation methods. For example, by coupling a separation means such as liquid chromatography or electrophoresis to the system, a novel analysis system is provided in which chemical, structural or molecular species in a fluid are first spatially separated and subsequently analyzed serially in the nanofluidic cell.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A flow cell comprising:
a body structure comprising an internal channel, an inlet port and an outlet port, wherein said inlet port and said outlet port are in flow communication with said internal channel;
said body structure further comprising a membrane enclosing a portion of said internal channel and defining a detection zone within said internal channel, wherein a thickness of said membrane is selected to allow the transmission of a probe beam within a selected energy range through said membrane and into said internal channel; and
wherein transverse dimensions of said internal channel outside of said detection zone are selected to provide a fluidic resistance outside of said detection zone that is less than a fluidic resistance within said detection zone.

2. The flow cell according to claim 1 wherein a thickness of said internal channel within said detection zone is on a micron to submicron scale.

3. (canceled)

4. The flow cell according to claim 1 wherein said thickness of said membrane is on a nanometer scale.

5. (canceled)

6. The flow cell according to 1 wherein an area of said membrane is less than approximately 1 mm².

7. The flow cell according to claim 1 wherein said internal channel further comprises trenches provided adjacent to said detection zone, wherein said trenches comprise transverse dimensions that are selected to provide a fluidic resistance outside of said detection zone that is less than a fluidic resistance within said detection zone.

8. (canceled)

9. The flow cell according to claim 1 wherein said probe beam is selected from the group consisting of an optical beam, an x-ray beam, and an electron beam.

10. (canceled)

11. The flow cell according to claim 1 wherein said membrane is a first membrane and wherein said body structure further comprises a second membrane on an opposing side of said internal channel within said detection zone, and wherein a thickness of said membrane is selected to allow the transmission of said probe beam through said membrane.

12. The flow cell according to claim 1 wherein said membrane comprises a material selected form the group consisting of silicon nitride, boron nitride, silicon carbide, silicon, silicon dioxide, carbon, diamond and other allotropes of carbon, molybdenum disulphide and graphene.

13. (canceled)

14. (canceled)

15. The flow cell according to claim 1 wherein said body structure includes:
a first substrate having a transparent layer provided on a surface thereof, wherein said transparent layer is transparent to said probe beam within a selected energy range;
an aperture formed in said first substrate, said aperture extending through said first substrate and exposing said membrane, said membrane forming a portion of said transparent layer;
a second substrate;
a spacer layer contacting said transparent layer and a surface of said second substrate, said spacer layer having provided therein an opening defining said internal channel, said internal channel in flow communication with said membrane within a detection zone of said internal channel, wherein said inlet port and said outlet port are provided in one of said first substrate and said second substrate; and
first and second trenches provided on adjacent sides of said detection zone within one of said first substrate and said second substrate, said trenches contacting said internal channel for increasing a thickness of said internal channel on either side of said detection zone;
wherein transverse dimensions of said trenches are selected to provide a fluidic resistance outside of said detection zone that is less than a fluidic resistance within said detection zone.

16. (canceled)

17. The flow cell according to claim 15 wherein said transparent layer comprises a material selected form the group consisting of silicon nitride, boron nitride, silicon carbide, silicon, silicon dioxide, carbon, diamond and other allotropes of carbon, molybdenum disulphide and graphene.

18. (canceled)

19. (canceled)

20. (canceled)

21. (canceled)

22. (canceled)

23. The flow cell according to claim 15 wherein said transparent layer is a first transparent layer and said aperture is a first aperture, and wherein said second substrate has a second transparent layer provided on a surface thereof, said second transparent layer contacting said spacer layer, wherein said second transparent layer is transparent to said probe beam within said selected energy range, and wherein said body structure further comprises a second aperture formed in said second substrate, said second aperture comprising an aperture extending through said second substrate and exposing a second membrane comprising a portion of said second transparent layer, and wherein said first aperture is aligned with said second aperture for the transmission of said probe beam through said flow cell.

24. (canceled)

25. (canceled)

26. The flow cell according to claim 15 wherein said spacer layer is formed from a material selected from the group consisting of silicon dioxide, polycrystalline silicon, amorphous silicon, photoresist, Teflon™ and titanium.

27. (canceled)

28. A system for controlling a thickness of an internal channel within a flow cell, said system comprising:
a flow cell according to claim 1;
a flow means for flowing a sample to said inlet port and removing said sample from said outlet port;
means for detecting a signal related to said thickness of said internal channel; and
a processing and control means for controlling said flow means in response to said signal for controlling said thickness of said internal channel.

29. An electron microscope system adapted for the analysis of a fluid sample within a fluidic cell, said system comprising:
an electron microscope comprising a chamber;
a flow cell according to claim 1, wherein said flow cell is provided within said chamber; and
a flow means for flowing said sample to said inlet port and removing said sample from said outlet port.

30. (canceled)

31. A method of analyzing a fluid sample with a flow cell, said flow cell comprising:
a body structure comprising an internal channel, an inlet port and an outlet port, wherein said inlet port and said outlet port are in flow communication with said internal channel;
said body structure further comprising a membrane enclosing a portion of said internal channel and defining a detection zone within said internal channel, wherein a thickness of said membrane is selected to allow the transmission of a probe beam within a selected energy range through said membrane and into said internal channel; and
wherein transverse dimensions of said internal channel outside of said detection zone are selected to provide a fluidic resistance outside of said detection zone that is less than a fluidic resistance within said detection zone;
the method comprising the steps of:
flowing said sample to said inlet port and through said internal channel;
directing said probe beam onto said membrane; and
detecting one of a reflected probe beam and a transmitted probe beam.

32. (canceled)

33. (canceled)

34. (canceled)

35. (canceled)

36. The method according to claim 31 wherein a thickness of said internal channel is actively controlled by:
detecting a signal related to said thickness of said internal channel;
processing said signal to obtain a feedback parameter related to a difference between a thickness of said internal channel and a desired thickness of said internal channel; and
controlling flow of said sample to optimize said feedback parameter.

37. (canceled)

38. (canceled)

39. (canceled)

40. (canceled)

41. (canceled)

42. (canceled)

43. A method for fabricating a flow cell, comprising the steps of:
a) providing an upper substrate;
b) depositing a transparent layer onto a bottom surface of said upper substrate, wherein said transparent layer is transparent to a probe beam within a selected energy range;
c) forming an aperture within said upper substrate, said aperture extending through said upper substrate, by removing a portion of said upper substrate and exposing a membrane comprising a portion of said transparent layer;
d) providing a lower substrate;
e) depositing a spacer layer onto one of said transparent layer of said upper substrate and an upper surface of said lower substrate, and removing a portion of said spacer layer to define a channel;
e) forming an inlet port and an outlet port in one of said upper substrate and said lower substrate;
f) forming first and second trenches provided on adjacent sides of said membrane within one of said upper substrate and said lower substrate; and
g) aligning and adhering said upper substrate and said lower substrate;
wherein said membrane defines a detection zone within said channel; and
wherein said channel is in flow communication with said membrane, said trenches, said inlet port and said outlet port for flowing a sample through said detection zone within said flow cell, and wherein said trenches comprise transverse dimensions selected to provide a fluidic resistance outside of said detection zone that is less than a fluidic resistance within said detection zone.

44. The method according to claim 43, wherein said aperture is a first aperture, the method further comprising the steps of:
after performing step (d), providing a second transparent layer on a top surface of said lower substrate, wherein said second transparent layer is transparent to said probe beam; and
forming a second aperture within said lower substrate, said second aperture extending through said lower substrate, by removing a portion of said lower substrate and exposing a second membrane comprising a portion of said second transparent layer;
wherein when said upper substrate is aligned and adhered with said lower substrate, said first aperture is aligned with said second aperture.

45. The method according to claim 43 wherein said transparent layer comprises a material selected form the group consisting of silicon nitride, boron nitride, silicon carbide, silicon, silicon dioxide, carbon, diamond and other allotropes of carbon, molybdenum disulphide and graphene.

46. The method according to claim 43 wherein said spacer layer is formed from a material selected form the group consisting of silicon dioxide, polycrystalline silicon, amorphous silicon, photoresist, Teflon™ and titanium.

47. (canceled)

48. (canceled)

49. (canceled)

50. (canceled)
